(19) United States
(12) Patent Application Publication
(10) Pub. No.: US 2014/0358810 A1
(43) Pub. Date: Dec. 4, 2014

(54) IDENTIFYING CANDIDATES FOR JOB OPENINGS USING A SCORING FUNCTION BASED ON FEATURES IN RESUMES AND JOB DESCRIPTIONS

(71) Applicant: Linkedln Corporation, Mountain View, CA (US)

(72) Inventors: David Hardtke, Oakland, CA (US); Jacob Bollinger, San Francisco, CA (US); Ben Martin, San Francisco, CA (US); Eduardo Vivas, Miami, FL (US)

(21) Appl. No.: 14/318,467

(22) Filed: Jun. 27, 2014

Related U.S. Application Data
(63) Continuation of application No. 13/662,312, filed on Oct. 26, 2012.

(51) Int. Cl. G06Q 10/10

(52) U.S. Cl. CPC G06Q 10/1053
USPC 705/321

(57) ABSTRACT

A computer-based method, and computer system, for matching candidates with job openings. The technology more particularly relates to methods of providing a candidate with a score for a particular job opening, where the score is derived from a comparison of features in the candidate's resume with job features in a description of the job opening, as well as use of external data gathered from other sources and based on information contained in the candidate's resume and/or in the description of the job opening. Particular features are weighted to take account of their significance in matching candidates to job openings in a statistical survey of such matching. The technology further provides for notifying employers that one or more high scoring candidates have been identified.

### CROSS-REFERENCE TO RELATED APPLICATIONS

The present application is a continuation of U.S. patent application Ser. No. 13/662,312, filed Oct. 26, 2012, which is incorporated herein by reference in its entirety.

### TECHNICAL FIELD

The technology described herein generally relates to computer-based methods of matching candidates with job openings. The technology more particularly relates to methods of providing a candidate with a score for a particular job opening, as well as notifying employers that one or more high scoring candidates for a job opening have been identified.

### BACKGROUND

The challenge of matching suitable candidates with job openings available at a given time is ever-present. Particularly in times of economic stress where very large numbers of candidates may be seeking a small number of openings, the review process can tax even the most experienced human reviewer. Conversely, a candidate may find it extremely difficult to locate a truly suitable position for themselves from among a large number that are being advertised. It is also becoming more common for employers to leave positions vacant rather than fill them with candidates who are not best-qualified, or who may require extensive initial training. For such employers, it is critical to be presented quickly with candidates who should be invited to interview. Candidates, on the other hand, want to focus their time on job openings that will lead to a high chance of securing an interview.

Computer automation of the process of matching candidates with particular openings has been attempted in the past. There prove to be a number of key limitations in existing methodologies, however, which mean that the most suitable candidates are often overlooked when trying to fill a given position. An example of one attempt at automation is described in Yi et al (J. A. Xing Yi, and W. B. Croft. “Matching resumes and jobs based on relevance models”, in SIGIR 2007 Proceedings, page 809, July 2007). In that study the authors attempted to accomplish automated resume-job matching utilizing Monster.com's database (see, e.g., www.monster.com/). The relevance models were based on actions taken by a recruiter that might be inferred as an implicit judgment about the likelihood of a resume-job match. Example indicia of a possible match would be downloading the resume or e-mailing the resume to oneself, whereas deleting the resume from consideration, and skipping over a candidate without further action would be examples of deciding that there was no match. The authors found that implicit feedback was insufficient to yield reliable results. This is likely to be because the feedback contains no information about discriminating features of the resume itself. A resume may be rejected for a mitigating factor such as distance between the candidate's home and the job opening, as well as because the candidate lacked relevant experience.

Therefore, one problem that has not been fully addressed is to properly ascertain a good set of features within both a candidate's resume and a description of a job opening that would lead to more reliable matching. Today's computer algorithms can additionally, however, obtain relevant information about candidates that is not necessarily present in their resumes but which is germane to the hiring process.

The advent of social media and its recent exponential growth as a global phenomenon have prompted many researchers to consider its use in a number of situations. Social media includes Internet based services that accept and store personal data from a number of users and permit those users to communicate with one another via messaging capabilities within the social media service and not outside of it, and permit users to control access to personal data stored in the service to selected other users of the service, as well as control or limit access to other individuals who are not users of the service. For the first time, personal and biographical data of large numbers of individuals are stored in one place and in a common format. To date, we have seen the development of novel methods and approaches to enhance our understanding of many complex principles, as diverse as knowledge evolution (see, e.g., D. Barbieri, “Deductive and inductive stream reasoning for semantic social media analytics”, Intelligent Systems, 25(6):32-41, 2010), and disease surveillance (C. Corley, “Text and structural data mining in web and social media”, Int. J. Environ. Res. Public Health, 7(2):596-615, 2010).

One key to the successful application of social media is to recognize the new types of information that are now made available, as well as to achieve ways of automating access to, and extraction of, useful data from that information so that it can be harnessed in other spheres, such as the challenge of matching candidates with job openings.

The discussion of the background herein is included to explain the context of the technology. This is not to be taken as an admission that any of the material referred to was published, known, or part of the common general knowledge as at the priority date of any of the claims found appended hereto.

Throughout the description and claims of the application, the word “comprise” and variations thereof, such as “comprising” and “comprises”, is not intended to exclude other additives, components, integers or steps.

### SUMMARY

The present technology is based on an approach in which a combination of information in a candidate's resume, a description of the job opening (the job description), and external data such as social media information about the candidate and salary information about the positions the candidate has held is utilized to inform a set of machine-learning algorithms that match job openings to candidates by calculating a score, referred to herein as a suitability score. The result is a scoring function, a tool that combats inefficiency in the labor market by automatically and rapidly surfacing optimal candidates.

The suitability score serves both sides of the hiring process, both allowing candidates to find their optimal job, as well as employers to find their optimal candidates, and thereby engenders productivity in the successful employment of the most-suited individuals as well as efficiency in locating those individuals from among large applicant pools.

The suitability score emulates optimal human behavior and, being automated, can be calculated at any time in order to get the most qualified candidates hired.

The present disclosure provides for a computer-based method for identifying a best-fit candidate for a job opening, the method performed on at least one computer having a processor, a memory and input/output capability, the method comprising: receiving one or more resumes of one or more candidates; receiving one or more descriptions of job openings provided by one or more employers; identifying a plurality of job features in each of the descriptions of job openings; for each resume of the one or more resumes, identifying a plurality of candidate features in the resume; calculating a score for each of the one or more descriptions of job openings, wherein the score is based on a match between the plurality of candidate features in the resume and the plurality of job features in the description of the job opening; creating a first list of scores associated with each of the one or more descriptions; identifying for each of the one or more descriptions those resumes in the first list whose score exceeds a first threshold fit; and communicating a notification of a selected resume to an employer if the selected resume has a score that exceeds the first threshold fit for a description of a job opening provided by that employer.

The present disclosure includes a computer-based method for quantifying the suitability of a candidate for a job opening, the method comprising: accepting a resume of the candidate; extracting a plurality of candidate features from the resume; receiving a job description of the job opening from a prospective employer; extracting a plurality of job features from the job description; for each feature of the plurality of candidate features, obtaining a feature score by calculating an overlap between the candidate feature and a corresponding job feature; combining the feature scores for the resume into a suitability score for the job opening; and notifying one or both of the candidate or the prospective employer if the suitability score exceeds a first suitability threshold.

The present disclosure additionally includes a computer system for matching candidates to job openings, the system comprising: a first input connection that accepts a resume from a candidate; a second input connection that accepts a description of a job opening from an employer; a memory to store the resume and the description; one or more processors configured with instructions to: identify candidate features in the resume; identify job features in the description; calculate a score based on a match of candidate features with job features; a communication device for alerting the candidate if the score exceeds a first threshold; and a communication device for alerting the employer if the score exceeds a second threshold.

### BRIEF DESCRIPTION OF THE DRAWINGS

FIG. 1 shows a computing apparatus for performing a process as described herein.

FIG. 2 shows a flow-chart of a process for matching resumes to job descriptions, as described herein.

FIG. 3 shows a flow-chart of a process for calculating a score that quantifies the level of fitness of a candidate for a job opening.

FIG. 4: A: Bar plot comparing the average scores from the HIRES study, for jobs to which people applied versus randomly selected resume-job pairs. B: Top reasons for disqualification of a candidate for a given position in the HIRES study.

FIG. 5: Plot between mean human scores from HIRES study and the suitability score for the same resume-job description pairs computed by methods described herein. The vertical error bars represent the error on the mean, and the horizontal error bars depict the suitability score bin range, in bins of 10. The HIRES scores are normalized to the range 1-100. The suitability scores in the range 0-30 are omitted from the figure.

FIGS. 6A, 6B-1, and 6B-2: Panel A: Clustering analysis of resume and job description data. Key information (e.g., the 4 key items: past job titles, employers, schools, and majors) were extracted from all the resumes in a database. A set of clustering analyses were performed to examine relationships between these categories of information. For example, for a particular major, what are the most frequently occurring job titles that a person has attained? Alternatively, does a particular employer prefer to hire people from a particular school or with a particular major? Through these analyses, it is possible to predict what jobs a person is most likely qualified for. Panels B-1 and B-2: Job titles for candidates who majored in Industrial engineering and Computational Information Systems. The area of each polygon is proportional to the number of persons having a job of that title, though the shape of a polygon and its position in a row are not important. Larger polygons are higher up the figure, for clarity. It can be seen that industrial engineering majors lead to a greater variety of job titles in the workplace than to computer information systems majors. In FIG. 6B-1, the lists of job titles for the lower rows are shown at the side of each row.

FIG. 7: Example external factors that can be used in computing a suitability score.

### DETAILED DESCRIPTION

The instant technology is directed to a computer apparatus and a computer-based method for identifying a best-fit candidate for a job opening by computing a suitability score for a members of a population of candidates measured against the job opening. The method is performed on at least one computer having a processor, a memory and input/output capability, but various steps may be distributed across more than one computer.

### Computing Apparatus

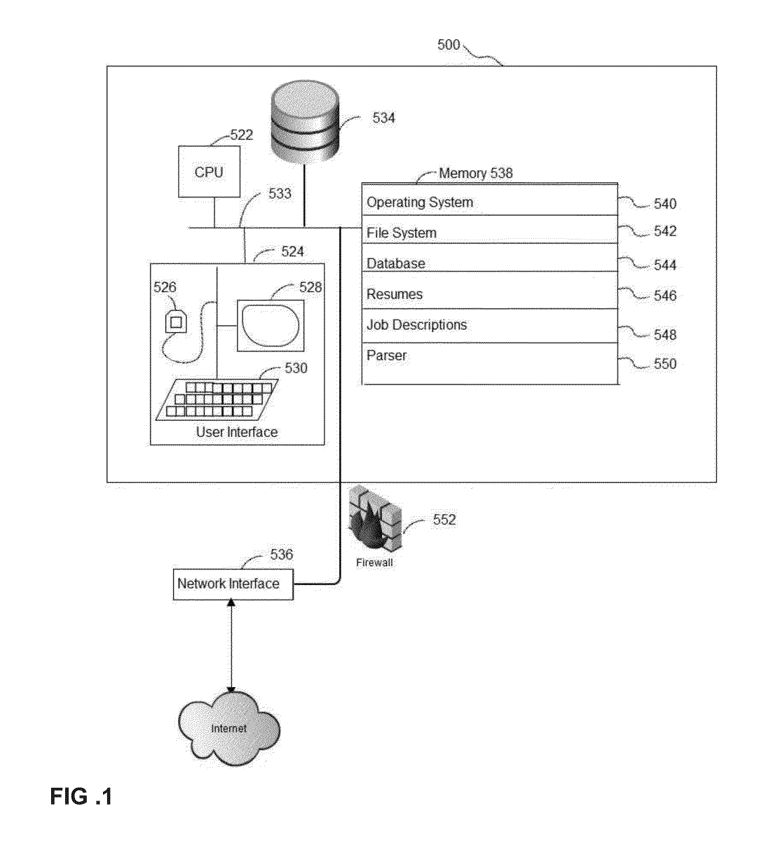

An exemplary general-purpose computing apparatus 500 suitable for practicing the methods described herein is depicted schematically in FIG. 1.

The computer system 500 comprises at least one data processing unit (CPU) 522, a memory 538, which will typically include both high speed random access memory as well as non-volatile memory (such as one or more magnetic disk drives), a user interface 524, one more disks 534, and at least one network or other communication interface connection 536 for communicating with other computers over a network, including the Internet, as well as other devices, such as via a high speed networking cable, or a wireless connection. There may optionally be a firewall 552 between the computer and the Internet. At least the CPU 522, memory 538, user interface 524, disk 534 and network interface 536, communicate with one another via at least one communication bus 533.

Memory 538 stores procedures and data, typically including some or all of: an operating system 540 for providing basic system services; one or more application programs, such as a parser routine 550, and a compiler (not shown in FIG. 1), a file system 542, one or more databases 544 that store resumes 546, job descriptions 548, and other information, and optionally a floating point coprocessor where necessary for carrying out high level mathematical operations. The methods of the present invention may also draw upon functions contained in one or more dynamically linked libraries, not shown in FIG. 1, but stored either in memory 538, or on disk 534.

The database and other routines shown in FIG. 1 as stored in memory 538 may instead, optionally, be stored on disk 534 where the amount of data in the database is too great to be efficiently stored in memory 538. The database may also instead, or in part, be stored on one or more remote computers that communicate with computer system 500 through network interface 536.

Memory 538 is encoded with instructions for receiving input from a candidate and for calculating a suitability score for the candidate's resume against a job description. Instructions further include programmed instructions for performing one or more of parsing, calculating a metric, and various statistical analyses.

Various implementations of the technology herein can be contemplated, particularly as performed on computing apparatuses of varying complexity, including, without limitation, workstations, PC's, laptops, notebooks, tablets, netbooks, and other mobile computing devices, including cell-phones, mobile phones, and personal digital assistants. The computing devices can have suitably configured processors, including, without limitation, graphics processors and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface 524, which may comprise a mouse 526, keyboard 530, and/or other items not shown in FIG. 1, such as a track-pad, track-ball, touch-screen, stylus, speech-recognition, gesture-recognition technology, or other input such as based on a user's eye-movement, or any subcombination or combination of inputs thereof.

The manner of operation of the technology, when reduced to an embodiment as one or more software modules, functions, or subroutines, can be in a batch-mode—as on a stored database of resumes processed in batches, or by interaction with a user who inputs specific instructions for a single resume.

The resume scores created by the technology herein can be displayed in tangible form, such as on one or more computer displays, such as a monitor, laptop display, or the screen of a tablet, notebook, netbook, or cellular phone. The resume scores can further be printed to paper form, stored as electronic files in a format for saving on a computer-readable medium or for transferring or sharing between computers, or projected onto a screen of an auditorium such as during a presentation.

ToolKit: The technology herein can be implemented in a manner that gives a user access to, and control over, basic functions that provide key elements of a score, including the contributions of various features to it. Certain default settings can be built in to a computer-implementation, but the user can be given as much choice as possible over the features that are used in calculating the score, thereby permitting a user to remove certain features from consideration or adjust their weightings, as applicable.

The toolkit can be operated via scripting tools, as well as or instead of a graphical user interface that offers touch-screen selection, and/or menu pull-downs, as applicable to the sophistication of the user. The manner of access to the underlying tools by a user is not in any way a limitation on the technology's novelty, inventiveness, or utility.

The computer functions for calculating a suitability score can be developed by a programmer of skill in the art. The functions can be implemented in a number and variety of programming languages, including, in some cases mixed implementations. For example, the functions as well as scripting functions can be programmed in C++, Java, Python, VisualBasic, Perl, .Net languages such as C#, and other equivalent languages not listed herein. The capability of the technology is not limited by or dependent on the underlying programming language used for implementation or control of access to the basic functions.

The technology herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, available from Microsoft Corporation); Apple iOS (including variants such as iOS3, iOS4, iOS5, and iOS6 and intervening updates to the same); Apple Macintosh operating systems such as OS9, OS 10.x (including but not limited to variants known as “Leopard”, “Snow Leopard”, “Lion”, and “Mountain Lion”); the UNIX operating system (e.g., Berkeley Standard version); and the Linux operating system (e.g., available from Red Hat Computing).

To the extent that a given implementation relies on other software components, already implemented, such as functions for basic mathematical operations, etc., those functions can be assumed to be accessible to a programmer of skill in the art.

Furthermore, it is to be understood that the executable instructions that cause a suitably-programmed computer to execute methods for calculating a suitability score, as described herein, can be stored and delivered in any appropriate computer-readable format. This can include, but is not limited to, a portable readable drive, such as a large capacity “hard-drive”, or a “pen-drive”, such as connects to a computer's USB port, and an internal drive to a computer, and a CD-Rom or an optical disk. It is further to be understood that while the executable instructions can be stored on a portable computer-readable medium and delivered in such tangible form to a purchaser or user, the executable instructions can also be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

### Matching Resumes and Job Openings

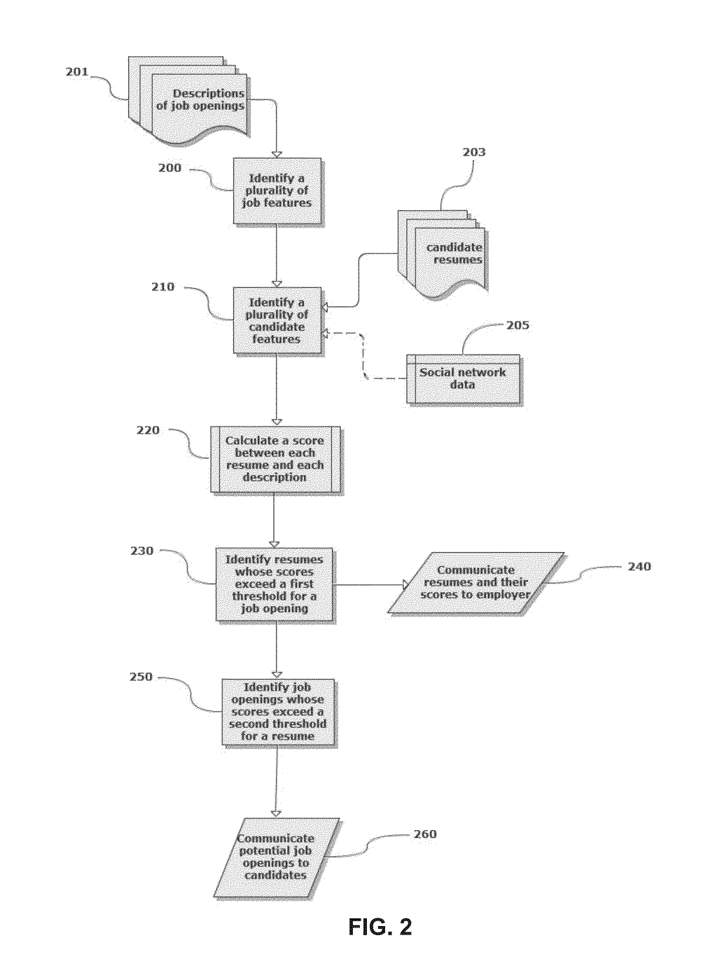

One embodiment of the technology herein is described with reference to FIG. 2, which shows a process flow-chart for identifying candidates for job openings using a scoring function based on features in resumes and job descriptions. The process is intended to be carried out on a computer system, such as one shown in FIG. 1.

One or more candidate resumes 203 are provided by one or more candidates to the computer system. A single candidate may provide more than one resume if that candidate wishes to tailor their expertise and experience towards different types of roles. A single candidate may also provide an updated resume at different points in time. The resumes 203 may be uploaded by the candidate or by a third party, for example, a recruiter. In one embodiment, a resume is filed via a web-based interface. In other embodiments, the candidate may create a resume on-the-fly by filling out a number of fields in one or more forms, such as by answering a questionnaire, in an online interface such as a web-browser. The fields are designed to provide to the computer system sufficient information about the candidate that his or her suitability for a job opening can be assessed. In other embodiments, a combination of a prepared resume with an online form is used. For example, an online form may ask a number of questions of a candidate that are designed to create a profile for that candidate, which contains information not in, or easily deducible from, the candidate's resume. At this stage, a candidate may indicate that they are seeking work in areas that are not represented on their resume if, for example, they are attempting to make a career change. By indicating such additional areas of desired employment, the candidate may ensure that his or her resume is compared with job openings outside of the areas of expertise that are explicitly represented on the resume. The candidate may elect to create certain login attributes so that their resume and/or profile are stored and are accessible to them for further updates or when applying for subsequent job openings.

It is also possible that resumes are submitted to the system on behalf of candidates by third party services.

One or more descriptions of job openings 201 are provided by one or more employers to a computer system. The descriptions of job openings 201 may be uploaded by, for example, a representative of the employer as filed via a web-based interface. An employer may alternatively or additionally elect to input one or more job openings by answering an online questionnaire and by filling out fields in one or more forms via an online interface such as a web-browser. The fields are designed to provide to the computer system sufficient information about the job opening that the suitability of one or more candidates can be assessed. An employer who has many job openings and/or who expects to use the system frequently will probably establish a secure login, or develop a portal or application program interface (API) to the system in order to facilitate efficient upload of positions as they become available.

The technology herein is not limited to a particular web browser version or type; it can be envisaged that the technology can be practiced with one or more of: Safari, Internet Explorer, FireFox, Chrome, or Opera, and any version thereof.

The files for the descriptions of the job openings, and the resumes, can be accepted in any of a variety of formats used for creating, storing, or sharing documents, including but not limited to those identified by file-name extensions: “.pdf” files from Adobe Software; “.doc” files from Microsoft Corporation, as used with Microsoft Word; “.wpf” files from Corel Corporation, as used with Word Perfect; “.html” files that are read and created by web-browsers; and plain text (“.txt”) files, as well as HR-XML files, as described at http://www.hr-xml.org/. The files preferably contain the text of the descriptions of the job openings in a form that is readable and parseable by the computer programs of the present technology. In some embodiments, the files may contain scanned portions of text that is converted to readable text by, for example, optical character recognition (OCR) software before it is parsed.

In some embodiments, the job descriptions can also be harvested from, e.g., one or more external databases of job openings. The descriptions of job openings and/or the candidate resumes are imported into the computer program via a direct link to some third party computer system or database. For example, the system may make a network connection to an employer or to a recruiter and access a remote repository of resumes or descriptions of job openings, and then upload a batch of those documents into the system. The documents may be retrieved and uploaded according to a set schedule, such as once-daily, for example at 2 am, or once weekly, or once fortnightly, or once monthly.

In other embodiments, the computer system may receive one or more sets of preferences for an employer, where the set of preferences for the employer contains at least one candidate feature required of any candidate who could be hired by that employer. In some embodiments, the set of preferences is not uploaded to the system by a third party such as the employer, but is determined by statistical analysis of previous decisions by that employer on candidates for other job openings with that employer.

For each description of a job opening that has been input into the system, the technology identifies 200 a plurality of job features. This may happen immediately, upon entry of the description into the system, or it may happen as part of a batch process so that after some number, say 20, 50, or 100, of descriptions are input, each is parsed to extract certain job features that are present. A particular description of a job opening may not be parsed in this way if, for example, the employer who submits it asks for it to be held for a period of time or if, for example, the job description is itself not readable in whole or in part. In the latter case, the employer or third party submitter is notified to resubmit the description.

In a preferred embodiment, there is a confirmation step. After a job description is uploaded, certain keywords or skills are suggested to the submitter based on similar job descriptions submitted previously by that party. The employer can then explicitly rate the relative importance of these suggested skills. For example, the submitter is asked whether the suggested keywords should be deleted, whether the keywords correspond to attributes that are essential for the position, or whether they represent credentials that are just nice to have.

For each resume of the one or more resumes that has been input into the system, in conjunction with a profile for that candidate if available, the technology identifies a plurality of candidate features 210 in the resume and the profile, if present. This may happen immediately, upon entry of the resume into the system, or it may happen as part of a batch process so that after some number, say 20, 50, or 100, of resumes are input, each is parsed to extract certain candidate features that are present. Alternatively, it may be that the system runs parsing operations on newly submitted resumes at set time intervals, such as hourly or daily, and adjustable according to the amount of new user traffic to the site. A particular resume may not be parsed in this way if, for example, the candidate who submits it asks for it to be held for a period of time or if, for example, the resume is itself not readable in whole or in part. In the latter case, the candidate is notified to resubmit the resume and it is parsed at a later time.

Additionally, if a candidate has given permission to do so, the system may communicate with one or more Internet-based social networks of which the candidate is a member, and extract further data and information about the candidate and store that further data and information in connection with the candidate's resume. Such data can be referred to herein as “external data” because it is data that is not directly submitted by the candidate and is not contained within the candidate's resume. In some instances, the data may be obtained by accessing the candidate's account with the social network, in others, the data may be limited to that data which is publicly accessible, such as to persons who are not themselves members of the social network, or who have the required connections to the candidate within that social network. Examples of social networks that may provide such data include, but are not limited to: Facebook, LinkediN, Twitter, Google+, MySpace, and Yahoo! Groups. The data obtained this way can include current and past employers of people who are connected to the candidate in their social network(s).

It is also possible for the system to access one or more other databases and retrieve external data relevant to the candidate's resume. For example, the system can extract the name of the school where the candidate obtained a bachelor's degree from the candidate's resume. From a separate database, the system can access the nationwide ranking of that school in the candidate's discipline, and add it to the candidate's profile, or use it as a feature in calculating a suitability score for the candidate.

It would be understood that, although FIG. 2 shows step 200 occurring before step 210, there is no requirement that either step occurs before the other. In fact, both steps, in practice may be being carried out all the time, such as concurrently, so that candidates are continually accessing the computer system to upload resumes and review job openings, and employers are continually accessing the computer system to upload descriptions of new job openings. The suitability of a given candidate for those positions available at the time will be assessed. Correspondingly, a given job opening will be matched against those candidates available in the system at a given time.

The computer system then takes each resume that has been uploaded in turn and proceeds to calculate a suitability score 220 (also, simply, a “score” herein) for each of the one or more descriptions of job openings that have also been accepted by the system, where the score is based on a match between the plurality of candidate features in the resume along with any features that have been extracted from the candidate's profile or social media or other external data, and the plurality of job features in the description of the job opening. Types of features of both candidate and job opening, and ways of quantifying the match between them in the form of a suitability score are described elsewhere herein.

The step of calculating a score for each resume relative to each description of a job opening could equally be viewed as the converse, considering each description in turn and calculating a score for each resume in the system. In total there would be as many as n×m calculations where n is the number of resumes, and m is the number of descriptions of job openings. This step can be intensive of computer processing power and therefore can be staged in a number of ways to improve efficiency. For example, it can be carried out at a set frequency, say once per 24 hours, or once per 48 hours, or once per week, over the whole database. It can be carried out in batches by, for example, considering a number of resumes, or a number of job openings, at a time. It can be carried out on one or more computers remote from the computer that has input and stored the resumes and descriptions of job openings so that processing power on the computer that accepts input from candidates and employers is freed up. Thus, a batch of descriptions of job openings could be transferred over a network to a remote computer. A single resume or batch of resumes are then transferred to the remote computer and suitability scores calculated for each resume-description pair. The scores are then transmitted back to the computer on which the resumes are stored. High scoring resume-job description pairs are identified and processed as described elsewhere herein. The remote computer or computers can be under the control of the same person or persons who control the computer that accepts the resumes and job descriptions. Alternatively, the remote computer or computers can be in “the cloud”, such as owned by a third party but making processing power available to remote users.

In a preferred embodiment, each resume has an associated tag indicating a preferred job type for the candidate, so that, for each resume, the suitability score is only calculated for job descriptions that include a feature that matches the preferred job type. This represents a considerable cost saving in that not all resume-job description pairs need to be calculated. As a consequence, a candidate who has specified a particular job type will not see a list of possibly suitable job openings that do not match that type, even though, had their scores been calculated they might have been suitable positions for that candidate.

In another preferred embodiment, an employer has identified a candidate feature that, if present in a candidate's resume, will cause the resume for that candidate to be excluded from calculation of scores for a job opening submitted by that employer. For example, an employer may prefer its future employees not to have worked for a particular competitor. In an alternative embodiment, the employer has identified a candidate feature that, if absent from a candidate's resume, will cause the resume for that candidate to be excluded from calculation of scores for a job opening submitted by that employer. For example an employer may require all candidates for all of its job openings to have achieved a particular certification. Candidates who do not list that certification on their resumes and whose social network data do not reveal the existence of that certification will not have their scores calculated for job openings from that employer.

In yet another embodiment, each resume has an associated tag indicating an interest level that the candidate has in finding employment. Interest tags include descriptions such as “active”, “interested”, “qualified”, or “inactive”. The tag can therefore be a binary quantity (e.g., “interested” or “not interested”), or a graduated quantity, expressing a degree of interest in seeking employment. For each resume, a suitability score against the descriptions of job openings is only calculated for candidates whose interest level exceeds a particular interest threshold. Such a tag can be used to decide whether a candidate is actively job searching and therefore whether calculating a suitability score is appropriate. In some embodiments, a candidate's status of “active” can be downgraded to “inactive” if they have not logged on to the system for a set period of time, for example 30 days, 90 days, 180 days, or 1 year. In which case, the candidate's resume will stop being used to calculate suitability scores until such time as they log in again or indicate that they are interested again.

Therefore, the potentially large number (n×m) of calculations of suitability scores can be reduced significantly by judicious use of filters or tags, separately or in combination with one another.

A result of calculating the scores is a first list of suitability scores associated with each of the one or more job descriptions where each score in the first list corresponds to the match between a resume and that job description.

In a preferred embodiment, there is a first threshold suitability score below which a candidate whose resume has been scored against a description is deemed to be a poor fit for a given job opening. For example, if scores lie in the range [0,100], a first threshold may be set by the system to be 75, 80, 85, or 90. The threshold may be adjusted upwards if there are a large number of high scoring candidates. An employer may choose a value for the first threshold so that they see more or fewer resumes at their discretion.

Additionally there may be, for each resume, a second list of suitability scores comprising one score associated with each of the one or more descriptions of job openings.

In a preferred embodiment, there is a second threshold score below which a job opening whose description has been scored against a resume is deemed to be a poor fit for a given candidate. For example, if scores lie in the range [0,100], a second threshold may be set by the system to be 75, 80, 85, or 90. The threshold may be adjusted upwards if there are a large number of high scoring descriptions for that candidate's resume. A candidate may choose a value for the second threshold so that they see more or fewer descriptions of job openings.

The choice of range [0,100] for the suitability score is purely for convenience. Other ranges, for example [0,5], [0,10], or [0,1000], are consistent with the overall practice of the technology herein, which is not limited to the range of values encompassed by the score.

Where a first threshold score has been set, the computer system identifies 230 for each of the one or more descriptions of job openings those resumes in the first list whose score exceeds the first threshold fit, and flags those resumes as selected resumes.

The computer system then communicates 240 a notification of one or more selected resumes to an employer, or other third party submitter of the description, if a selected resume has a score that exceeds the first threshold fit for the description of a job opening provided by that employer. The notification can be communicated by any electronic means, including by e-mail, text message, FAX (facsimile), or some other automatically generated written notification. In one embodiment, the notification is a message stored on the computer system that the employer will see on their next login to the system. So the notification need not be a copy of the resume itself, but simply an indication that the employer or recruiter should access the system and view the resume and profile of a particular candidate.

Where a second threshold score has been set, the computer system identifies 250 for each of the candidates one or more job openings whose descriptions are in the second list and whose score exceeds the second threshold fit, and flags those job descriptions as potential job openings for that candidate.

The computer system then communicates 260 a notification of one or more potential job openings to a candidate, if a description for that job opening has a score that exceeds the second threshold fit. The notification can be communicated by any electronic means, including by e-mail, text message, FAX (facsimile), or some other automatically generated written notification. In one embodiment, the notification is a message stored on the computer system that the candidate will see on their next login to the system. The notification to the candidate need not be a copy of the job description itself, but simply an indication that the candidate should access the system and view the description of a particular job opening.

It would be understood that, although FIG. 2 shows step 230 occurring before step 250, there is no requirement that either step occurs before the other. In fact, both steps, in practice are being carried out according to the desires and preferences of candidates and employers or third party submitters. Accordingly, candidates may elect to receive notifications of job openings for which they have high scores at some frequency of their choosing. Correspondingly, employers may elect to instruct the computer system to notify them at certain frequencies of candidates who appear well suited to particular openings. An employer may elect to receive all notifications at the same specified frequently, for example, daily, weekly, bi-weekly, or monthly. Alternatively, an employer may set the frequency for each job opening, or according to category or level of job opening, as need and urgency dictates. In either case, an employer or candidate can elect to have, respectively, a resume or job opening sent to them at any time if the score for that resume-description combination exceeds an alert threshold.

It is also true that the system may be installed in a location where only employers or recruiters are seeking information, in which case the only data that is presented is the list of suitable candidates for a given position. Conversely, the system may be set up in such a way that it exclusively provides services to candidates, in which case the only data that is presented to a given candidate is the list of possible job openings for which that candidate is suitable.

In some embodiments, there is an additional, preferred threshold fit, that is higher than either the first or the second threshold fits. For example, it may be set to 95 or higher, on a score range of [0,100], where the first threshold fit was set to be a lower number such as 80, 95, or 90. When the score for the match of a candidate's resume to a job description exceeds the preferred threshold fit, an immediate notification can be sent to either the candidate or the employer or both. Such an immediate notification would be one that would be outside of the normal frequency of notification that either candidate or employer customarily received. By enabling such a possibility, both a candidate and an employer can, independently, potentially be on notice of a rare event of a very high scoring match.

Whenever an employer is provided with a list of candidates whose suitability scores exceed a first or a second threshold, the employer is able to review the candidates' resumes, profiles, and any other available data, and make a decision on whether to invite one or more of the candidates to formally apply for the job opening, or to come straight to an interview.

In an alternative embodiment, an employer can request that scores are calculated for candidates who have already applied for a job opening, for example by communicating their resumes to the system in conjunction with a description of the job opening.

Correspondingly, whenever a candidate receives a list of job openings whose suitability scores exceed a first or a second threshold, the candidate can review the descriptions of the job openings, and make a decision on whether to apply for the job opening and/or to send their resume directly to the employer or third party submitter.

In this way, by pairing up candidates who have a high likelihood of being suitable for a given job opening, the chances of those candidates securing a job interview are thereby enhanced. The suitability score cannot provide a direct indication of the likelihood of a candidate being actually hired into a position or, correspondingly, that the employer will actually fill a job opening with one of the possibly suitable candidates. Nevertheless, winnowing down a large field of candidates to a small number who would make good interview prospects will be of value to many employers who currently have to rely on making sure that their listings are visible in the right locations but must also rely somewhat on chance that the best-suited candidates will surface. Correspondingly, candidates who today are faced with a daunting task of reviewing hundreds of job openings and having little quantifiable prospect of reaching an interview in any of them, will find the process of identifying that small number of positions for which they are best suited to have a positive impact on their job searches.

Accordingly, one economic model that may make sense for the technology herein is one in which employers pay to access information about candidates who are well-suited, according to a suitability score, for a particular job opening. Payment schedules can include periodic, e.g., monthly, subscriptions, or pay-per-use models.

### Suitability Score

The suitability score, S, is a composite quantity made up of contributions from various features that are found in descriptions of job openings, in candidate resumes, and in various external data, such as may be obtained from social media. In a manner akin to how a FICO score quantifies a person's credit risk, the suitability score quantifies a candidate's viability, but for a particular position, and will greatly accelerate employers' ability to identify and hire the most elite and qualified candidates. In the same way, it will also help job seekers to immediately find job openings best suited to their experience, qualifications, and skill sets.

Once a candidate's resume and a description of a job opening are input into the system, a number (say 50) of parallel processes can be run to calculate a list of features such as those defined in Table 1 herein. The data is transmitted back to the originating process and assembled into a list that comprises, for each defined feature a numerical value. This is a vector of values. The ranges of the various values that correspond to good-fit and bad-fit resumes are generally known. The suitability score is computed from a mathematical function that takes the vector of values and outputs a single number. The overall value of this final formula is heavily influenced by the discriminating power of good-match features. A normalization can be achieved by, for example, dividing by the total possible length of feature space.

In certain embodiments, the values of certain individual features are examined, after a suitability score has been calculated. For example, for a certain employer or category of employer, values of certain scores can be used to apply penalties to candidates. This is another way of filtering out certain resumes from reaching an employer.

A feature, from which S is composed, is defined as a function that takes a single resume, from a candidate, and a single description of a job opening, and returns a numeric value, or null if the feature cannot be calculated. In some embodiments, the contributions of the various features to the suitability score have been derived from a statistical analysis of human-judged matches between resumes and job openings.

Some features rely upon simple matching between the job description and resume (e.g., skills), whereas other more sophisticated features employ synonym sets to identify similar terms that may not be known outside an area of expertise. For example, a job description for a software programmer requiring knowledge of Java may be suitably filled by a candidate who lists j2ee on their resume. Other, even more sophisticated features examined historical relationships for important resume characteristics (e.g., prior employer, school attended, subject area of major, previous job titles) across the resume database. For example, it can be gleaned that Disney often hires people from state schools while the insurance company AllState prefers university graduates.

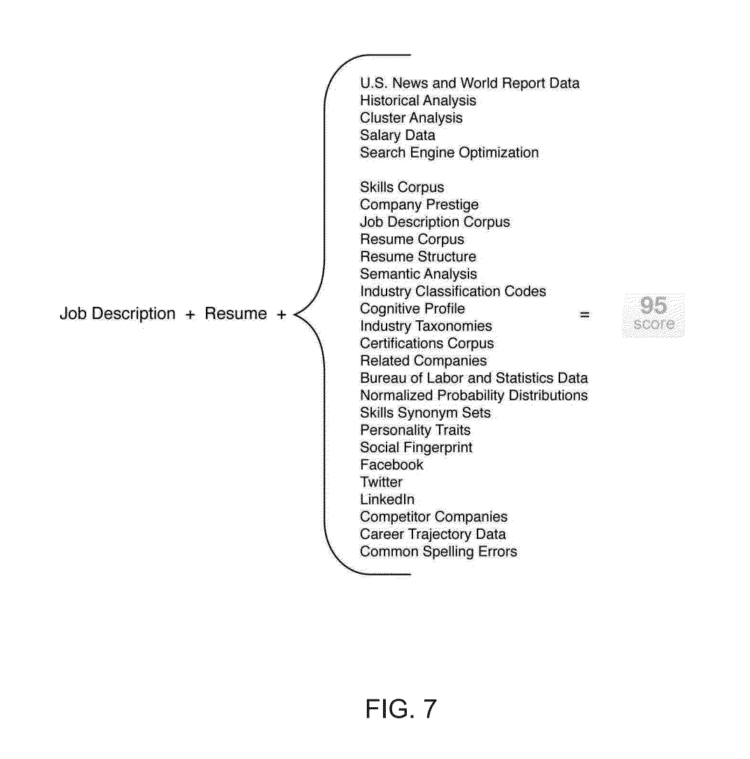

Other possible features include matching managerial qualifications to manager-level job openings, deducing secondary information from industry taxonomies; inverse document frequencies based upon in-house resume and job description corpuses; quantifying gaps in employment or frequency of job-hopping; whether an applicant is overqualified; previous versus current salary expectations; career trajectory; company prestige; whether an applicant previously worked for a competitor of the potential employer; required and desired skills; certifications; school rank; education timeline; several different semantic relationships between the resume and job description; resume and job description spectral density; level of social activity (for example, number of first-level connections in a social network); company connections (for example, how many people in the candidate's social network work at the same company as listing the job opening); social network size; personality traits; cognitive profile; unique analysis of data from the Bureau of Labor and Statistics and many other available sources; SIC codes; SEO, etc. Thus, in addition to the job description and resume, many additional external data sources are utilized for each suitability score calculation (FIG. 7).

Before the suitability score can be calculated, a plurality of job features is extracted from the description for a given job opening. Additionally, a plurality of candidate features is extracted from a resume of a candidate.

A feature score Fᵢ(u,j) for a candidate (user) u and a job j, is calculated. For each feature that is found in both the resume and the description, an overlap between the candidate feature and the corresponding job feature is calculated, thereby creating a feature score for that feature. Other features also contribute to the suitability score, but via metrics other than a simple overlap. For example, a piece of external data for a candidate may contribute to the suitability score even though that piece of data is not also found within a job description.

A suitability score for a candidate against the job opening is created by combining each of the feature scores for which an overlap has been calculated, along with feature scores for other features that have been determined to be relevant.

In some embodiments, the suitability score is calculated according to a non-linear superposition of feature scores, as further described elsewhere herein.

Typical features amongst the plurality of candidate features, extracted from a candidate's resume, include, but are not limited to: job title for each of one or more jobs previously held by the candidate; length of time the candidate held each of one or more previous jobs; subject matter of each of one or more qualifications obtained by the candidate; job title of most recent job held by candidate; whether the candidate has previously held a management position; highest educational level attained by candidate; and number of commonly mis-spelled words in the candidate's resume. Other features, drawn from external data, include: ranking of school attended.

An extended list of features that can be considered when computing a suitability score is shown in Table 1, comprising sub-parts labeled Tables 1A-1M.

In Table 1A, all of the features are calculated as cosine similarities or sums of cosine similarities. When comparing a portion of the description of the job opening with a portion of a candidate's resume, the cosine similarity is calculated as the vector cosine of the word vectors formed after stop-word removal. Each cosine similarity takes a value between 0 and 1. During parsing of a job description or resume, common words (such as “the”, “an”, “a”, “and”) are identified and removed. These words are often called “stop words”. The remaining words, or “non-common” words or “tokens”, are considered further in the analysis. Also, during parsing, tokenizing is the process of identifying non-stop words in a sentence. Usually a space or item of punctuation is taken to be the delimiter used in identifying tokens. Some special strings, however, such as e-mail addresses and phone numbers, are not split in this way.

Table 1B lists Inverse Document Features (IDF's). “TF” stands for “Term Frequency”, which is how often a term appears in a single document. “IDF”, on the other hand, is calculated for all documents in a corpus, and defines how often a term appears in the total, modulo its appearance (i.e., multiple instances in a single document count only once). The features in Table 1B determine the similarity of the text of the job description and the text of the candidate's resume by measuring the amount of overlap between words in the two documents, and by weighting that overlap by the inverse document frequency of those words in order to assess how important a word is. Unique terms appear least often but can be most significant. The inverse document frequency of a word is a measure of how rare/common that word is in the set of documents studied. Thus, a very common word (such as a preposition) receives a low weighting.

Table 10 lists various miscellaneous features.

Table 1D lists features that are based on various intrinsic properties of a candidate's resume, for example whether certain sections are present or absent. In some embodiments, only one of wordcount and length (in characters) are actually used. In other embodiments, either of these quantities is normalized to an average over the whole database. Lexical diversity can be a normalized quantity.

Table 1 E lists various features based on the education and skills of candidate and those required by the Job Opening.

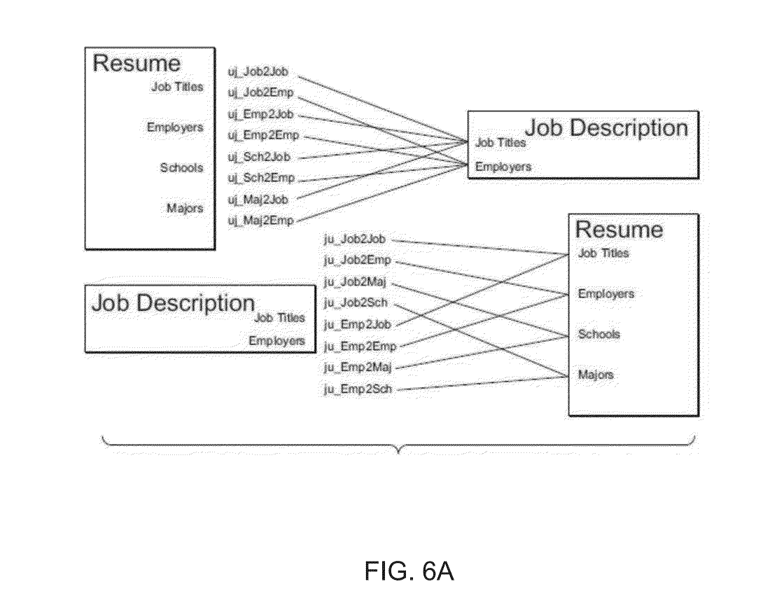

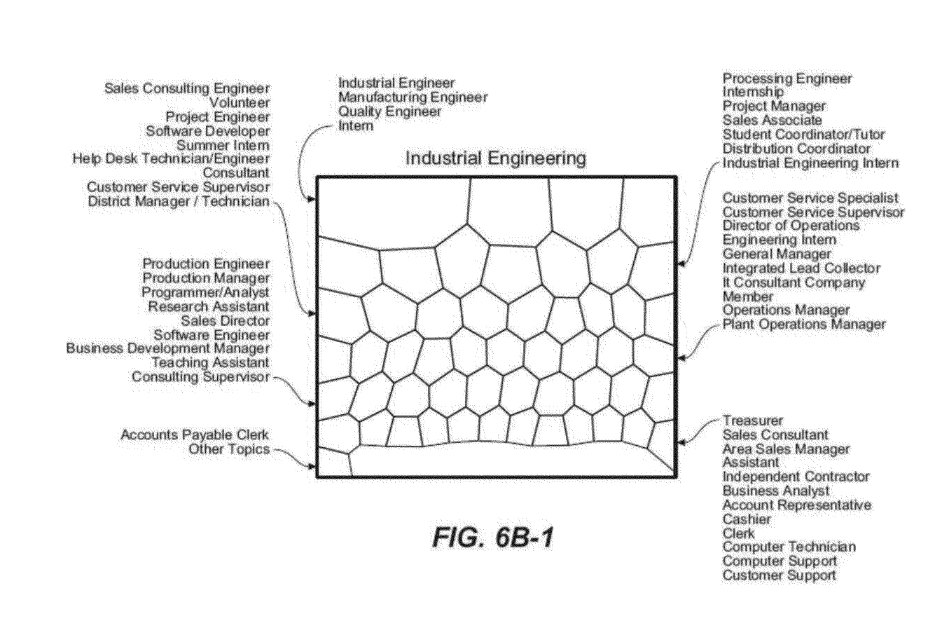

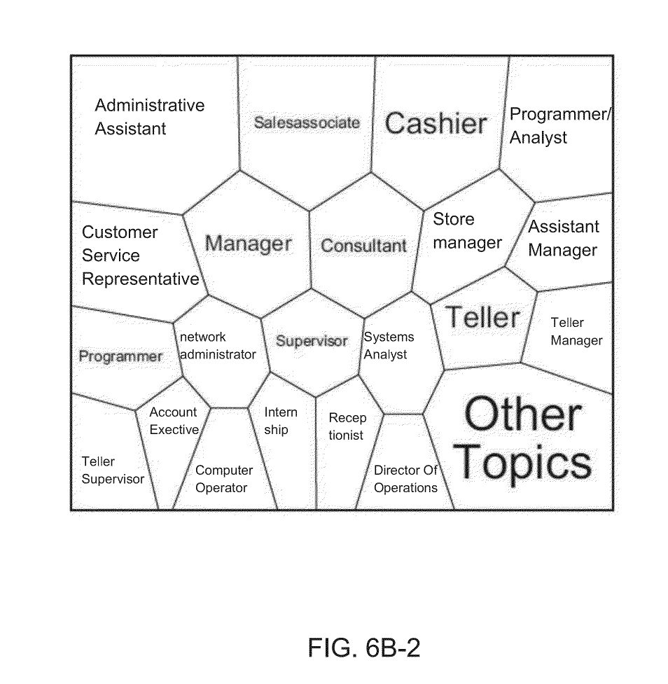

Tables 1F and 1G list features based on cluster analysis of, respectively, resumes, and job descriptions. For the former, more than 500,000 resumes were used to generate lists containing job titles associated with the most-often occurring majors, schools attended, employers, etc., within those resumes. For each of these quantities, all of the job titles that people with a particular value of that quantity had in their job history were gathered and then sorted according to the number of occurrences, such that the most often occurring job titles for that quantity rose to the top of the respective list. This is in general only done for the most commonly occurring items (e.g., the most commonly occurring majors, or schools attended). To calculate the value of the feature for a new resume, the quantity (major, school attended, former employer, etc.) is extracted and if that quantity is one of those commonly listed, the job title from the description of the job opening is then compared to the list of job titles for that quantity via regular expression matching. If the quantity is not one of those commonly listed it may be ignored; the method generally requires sufficient statistics for a feature. FIG. 6 shows an example of how cluster analysis permits discovery of secondary information about certain key terms in a candidate's resume.

Table 1H lists various features that are based on data from external sources (other than from social media).

Table 1J lists various features that are based on social network data obtained for a candidate.

Table 1K lists several logical quantities related to whether the job opening is for a management level position and whether the candidate has management experience. The feature “true_orialse” is different from ‘chieforindian’, described hereinbelow, in that it uses the HR-XML classification of fields in the resume and job description.

Table 1L lists further miscellaneous features.

Table 1M lists features derived by matching the Standard Occupational Classification (SOC) code of a job title and the SOC code of a candidate's previous job titles. The Standard Occupational Classification (the latest version of which was published in 2010, see, e.g., www.bls.gov/SOC/#classification) is a way of numerically labeling the category of a job title, and is curated by the U.S. Bureau of Labor Statistics. The numbers in a SOC (e.g. 11-3011) correspond to a major group label, a minor group, a broad category, and a detailed occupation. Each job title is represented by a pair of numbers, however.

The feature “chief_or_indian” assesses a candidate's experience and whether there is a managerial match is evaluated. This feature calculates Standard Occupation Classification (SOC) codes for the job listing title and titles of positions in the candidate's work history. Based on the SOC codes for the various positions, it is determined whether the job opening is for a management or non-management position and whether the candidate has had management level experience. The value of this feature is returned as either 0 or 1 (binary). This feature utilizes different source data from the feature true_or_false.

TABLE 1A
Features based on Candidate's Employment History

| Name of Feature | Technical Description | Verbal Description |
|---|---|---|
| body_vs_description | Compare the body of the job description with | Overlap between non |
| | the body of a candidate's employment | common words in the |
| | history. For each job in a candidate's history, | job description and |
| | there is a value between 0 and 1. This | candidate's positions |
| | feature is additive across all previous | listed in the |
| | positions in a candidate's history so the | experience section of |
| | feature value can be greater than 1.0. | their resume. |
| Body_vs_title | Same as above, but compares the body in | “” |
| | the job description to the title of positions in a | |
| | candidate's employment history. | |
| title_vs_description | Same as above, but compares the job title in | “” |
| | the job description to the bodies of positions | |
| | in a candidate's employment history. | |
| title_vs_title | Same as above, but compares the job title in | “” |
| | the job description to the titles of positions in | |
| | a candidate's employment history. | |
| body_vs_lastdescription | The next 4 features are identical to the | Overlap between non |
| | features above except for the fact that they | common words in job |
| | only consider the most recent job. Hence, | description and |
| | the values are between 0 and 1.0. | candidate's most |
| | | recent job. |
| Body_vs_lasttitle | body of job description vs. title of candidates | “” |
| | last position | |
| title_vs_lastdescription | job title in job description vs. description of | “” |
| | candidate's last position | |
| title_vs_lasttitle | job title in job description vs. title of | “” |
| | candidate's last position | |

TABLE 1B
Inverse Document Features

| Name of Feature | Technical Description | Verbal Description |
|---|---|---|
| cosim | The TF-IDF cosine similarity makes a vector | The IDF Cosine |
| | out of the TF-IDF values of the unique set of | Similarity feature |
| | tokens in the job description and resume and | calculates how “rare” a |
| | calculates the cosine similarity of those two | word is on a resume |
| | vectors. | (as compared to other |
| | | resumes) and does |
| | | the same for the job |
| | | description. It then |
| | | measures how |
| | | relevant these “rare” |
| | | words are to each |
| | | other. |
| jaccard | The Jaccard Similarity of a job-resume pair is | The Jaccard Similarity |
| | the size of the intersection of the set of | measures the difference |
| | tokens of the documents divided by the size | between a job |
| | of the union of the set of tokens: | post and a resume by |
| | \|A Intersection B\|/\|A Union B\|. | dividing the number of |
| | | words they do share |
| | | by the total number of |
| | | words in both. |
| sumscore | The Sumscore feature is the sum of the TF- | The Sumscore of a job |
| | IDF values for the tokens in the intersecting | description and |
| | set of tokens between a job-resume pair. | resume finds the |
| | The lower bound of this feature is 0. There is | words that the two |
| | no upper bound. | share and measures |
| | | how common those |
| | | words are on |
| | | resumes. For example, |
| | | the word |
| | | “make” would get a |
| | | low number and the |
| | | word “phlebotomist” |
| | | would get a high num- |
| | | ber. Adding up all of |
| | | these numbers for the |
| | | words that the job and |
| | | resume share gives |
| | | you the Sumscore. |

TABLE 1C
Miscellaneous Features

| Name of Feature | Technical Description | Verbal Description |
|---|---|---|
| randomfeature | This feature is just a random number | The random number |
| | between 0 and 1. It is calculated to ensure | may be calculated by |
| | that there are no nuisance variables in the | any standard way of |
| | feature calculations. | computing a random |
| | | number, for example |
| | | by starting with a |
| | | seed. |

TABLE 1D
Aspects of Resume style

| Name of Feature | Technical Description | Verbal Description |
|---|---|---|
| hasachievements | 1 if the resume has an achievement section | Does the candidate |
| | (according to an HR-XML parser), 0 | have an achievements |
| | otherwise. | section on their |
| | | resume? |
| hascontacts | 1 if the resume has a contact section | Does the candidate |
| | (according to an HR-XML parser), 0 | have an achievements |
| | otherwise. | section on their |
| | | resume? |
| hasobjective | 1 if the resume has an objective section | Does the candidate |
| | (according the an HR-XML parser, 0 | have an objective |
| | otherwise) | section on their |
| | | resume? |
| length | number of characters in the resume. | Total number of |
| | | characters in the |
| | | resume |
| wordcount | number of words in the resume. | Total number of words |
| | | in the resume. |
| spellcheckfeature | The Spellcheck feature takes a list of over | The Spellcheck |
| | 3,000 commonly misspelled words and does | feature measures the |
| | a regular expression search for those words | number of commonly |
| | in a candidate's resume. The Spellcheck | misspelled words in a |
| | score is the size of the set of misspelled word | resume. |
| | matches in a resume. | |
| lexdivfeature:stemd | The Stemmed Lexical Diversity feature stems | The Stemmed Lexical |
| | each token in a resume using the Porter | Diversity feature |
| | Stemmer. For example, it turns the words | measure the |
| | “turning” and “turned” into “turn”. It then | “richness” of root |
| | divides the number of unique stemmed | words in a resume. It |
| | tokens by the total number of tokens. | counts the number of |
| | | different stemmed |
| | | words and divides that |
| | | by the total number of |
| | | words. |
| lexdivfeature:whole | The Lexical Diversity feature calculates the | The Lexical Diversity |
| | number of unique tokens in a resume divided | feature measures the |
| | by the total number of tokens. | “richness” of text in a |
| | | resume by counting |
| | | the number of different |
| | | words in a resume and |
| | | dividing that by the |
| | | total number of words |
| | | in the resume. |

TABLE 1E
Features Based on Education and Skills of Candidate and Job Opening

| Name of Feature | Technical Description | Verbal Description |
|---|---|---|
| edmatchfeature | The level of education achieved by the | Do the education |
| | applicant and required by the job are placed | levels of candidate |
| | into one of 20 classes of education. This | and job description |
| | feature calculates the difference between the | match? |
| | classes, where 0 is a perfect match. | |
| jedreqfeature | This feature calculates the required education | What is the required |
| | level for the job opening from a set of 20 | education level for the |
| | classes of education level where a score of | job? |
| | 20 is postdoctorate. | |
| skillsfeature | This feature takes parsed ‘other skills’ from | Does the candidate |
| | the job description, converts them to regular | have the skills for the |
| | expressions (>6 characters) and searches the | job? |
| | entire resume for these strings. It then takes | |
| | the number of found instances and divides by | |
| | the number of skills from the job description. | |
| | Value is between 0 and 1. | |
| reqskillsfeature | Same as above except uses ‘required skills’ | Does the candidate |
| | parsed from the job description. | have the required |
| | | skills for the job? |
| reqskillsmajfeature | Compares the majors found in the resume | Does the candidate |
| | with ‘required skills’ parsed from the job | have the required |
| | description, as at times the required major for | major for the job? |
| | the job is found there. | |
| language features | Returns 1 if a language required for the job | Does the job require a |
| | opening is listed by the candidate as a | foreign language? |
| | language in which they are fluent. Returns 0, | Does the candidate |
| | otherwise. | speak that language? |
| expmatchfeature | If a job specifies the number of years of | Does the candidate |
| | relevant experience that are required, the | have the requisite |
| | system checks to see if a candidate has the | number of years' |
| | necessary number of years experience. The | experience? |
| | system looks at overlapping keywords | |
| | between the job description and each of the | |
| | candidate's previous positions to see if it is | |
| | above a necessary threshold to be called | |
| | “relevant”. If the sum of the years of relevant | |
| | experience for a candidate is equal to or | |
| | greater than that required by the job, then this | |
| | feature gets a value of 1. If not, then it gets a | |
| | value of 0. | |
| titleskillsfeature | This feature looks for specified skills in the | Does the candidate |
| | job title. If there is a specific skill in the job | have skills required by |
| | title, then the candidate must have this skill in | the title of the job |
| | their resume to get a value of 1 for this | opening? |
| | feature. Else, if they do not, they get a value | |
| | of 0. For example, a job title of “Software | |
| | Engineer - PHP” would require the candidate | |
| | to have “PHP” as a skill in their resume to get | |
| | credit for this feature. | |
| title_match_feature | if the job title is exactly 2 words, then this | Has the candidate had |
| | feature finds exact matches in the candidate's | identically the same |
| | profile. E.g., if a job has the title “PHP | job before? |
| | Engineer”, then the candidate must have that | |
| | exact title in their resume to get a value of 1 | |
| | for this feature. Else, it gets a value of 0. | |
| reqskills_sh_feature | Same as above except the ‘required skills’ | Does the candidate |
| | section is used. | have “small word” |
| | | required skills for the |
| | | job opening? |
| certfeature | The Certification feature does a regular | The Certification |
| | expression search of the job description for | feature looks for certi- |
| | certifications names (and their various | fications mentioned in |
| | synonyms) from a list of common | the job description. If |
| | certifications and licenses to do business. If | one or more is found, |
| | 1 or more certifications are found in the job | then we search for |
| | description, the same regular expression | those same certi- |
| | search is conducted for the resume in the job- | fications in the resume |
| | resume pair. If the certification sets are | associated with |
| | identical, then a value of 1 is assigned. | the job. If the resume |
| | Otherwise, a value of 0 is assigned. | has the same certi- |
| | | fications mentioned |
| | | as the job, then the |
| | | person gets a Certi- |
| | | fication score of 1. |
| | | Otherwise, the person |
| | | gets a 0. Even if they |
| | | have 2 out of 3 |
| | | certifications mentioned |
| | | in the job descripttion, |
| | | they still get a 0. |

TABLE 1F
Features based on Cluster Analysis of resumes

| Name of Feature | Technical Description | Verbal Description |
|---|---|---|
| uj_maj2jobfeature | Cluster analysis (candidate seed): This | Have people with this |
| | feature used >500,000 resumes to generate | major had this type of |
| | 3,000 lists containing job titles associated | job before? |
| | with the most-often occurring majors within | |
| | those resumes. For each of these majors, all | |
| | of the job titles that people with that major | |
| | had in their job history were gathered and | |
| | then sorted according to the number of | |
| | occurrences, such that the most often occurring | |
| | job titles for that major rose to the top of the | |
| | list. For a new resume, the major is extracted; | |
| | if that major is one of those 3,000 majors, the | |
| | job title from the description of the job | |
| | opening is then compared to the list via | |
| | regular expression matching. A match or | |
| | matches higher up on the list results in a | |
| | better score for this feature. | |
| uj_sch2jobfeature | Same as above except the schools attended | Have people who |
| | are clustered, in place of the majors, and the | attended this school |
| | score is based on job titles held by others | had this type of job |
| | from that school. | before? |
| uj_emp2jobfeature | Same as above except the previous | Have people who |
| | employers are clustered and the score is | worked for this |
| | based on job titles held by others who were | company had this type |
| | employed by that company. | of job before? |
| uj_job2jobfeature | Same as above except the previous job titles | Have people who had |
| | are clustered and the score is based on job | this job title had this |
| | titles held by others who were held a job with | type of job before? |
| | that title before. | |
| uj_sch2empfeature | Same as above except the schools attended | Have people who |
| | are used from the resume and previous | attended this school |
| | employers are clustered and the employer | worked for this |
| | name is used from the job description. | company before? |
| uj_maj2empfeature | Same as above except the majors are | Have people who |
| | clustered and used from the resume. | have this major |
| | | worked for this |
| | | company before? |
| uj_emp2empfeature | Same as above except the previous | Have people who |
| | employers are clustered and used from the | worked for this |
| | resume. | company worked for |
| | | the company of the job |
| | | opening before? |
| uj_job2empfeature | Same as above except the previous job titles | Have people who had |
| | are clustered and used from the resume | this job worked for the |
| | | company of the job |
| | | opening before? |

TABLE 1G
Features Based on Cluster Analysis of Job Descriptions

| Name of Feature | Technical Description | Verbal Description |
|---|---|---|
| ju_emp2majfeature | Same as in Table 1G except the employer is | Have people who |
| | extracted from the job description and | worked for the |
| | schools attended are clustered and the | company with the job |
| | school is used from the resume. | opening had the |
| | | candidate's major |
| | | before? |
| ju_emp2schfeature | Same as above except the schools attended | Have people who |
| | are clustered and used from the resume. | worked for the |
| | | company with the job |
| | | opening attended the |
| | | candidate's school |
| | | before? |
| ju_emp2jobfeature | Same as above except previous job titles are | Have people who |
| | clustered and used from the resume. | worked for the |
| | | company with the job |
| | | opening had the |
| | | candidate's previous |
| | | job title(s) before? |
| ju_emp2empfeature | Same as above except previous employers | Have people who |
| | are clustered and used from the resume. | worked for the |
| | | company with the job |
| | | opening worked for |
| | | the candidate's |
| | | previous employers |
| | | before? |
| ju_job2majfeature | Same as above except the job title is used | Have people with |
| | from the job description and majors are | experience in the job |
| | clustered and majors are used from the | title that is open had |
| | resume. | the candidate's major |
| | | before? |
| ju_job2schfeature | Same as above except schools attended are | Have people with |
| | used from the resume. | experience in the job |
| | | title that is open |
| | | attended the |
| | | candidate's school |
| | | before? |
| ju_job2jobfeature | Same as above except previous job titles are | Have people with |
| | clustered and used from the resume. | experience in the job |
| | | title that is open had |
| | | the candidate's job |
| | | title(s) before? |
| ju_job2empfeature | Same as above except employers are | Have people with |
| | clustered and used from the resume. | experience in the job |
| | | title that is open |
| | | worked at the |
| | | candidate's previous |
| | | employers before? |

TABLE 1H
Features based on Data from External Sources

| Name of Feature | Technical Description | Verbal Description |
|---|---|---|
| rankfeature | This feature gathers schools attended from | Ranks schools |
| | the resume. A list of rankings was created | attended according to |
| | from U.S. News and World Report's rankings, | U.S. News and World |
| | as well as the 200 most-often occurring | Report, accredited |
| | schools from known user profiles. A separate | schools. |
| | list of all accredited schools was also used. A | This feature can be |
| | ranking score is returned if the school from | calculated for each |
| | the resume is found in the ranks list, an | school attended by a |
| | Arbitrary value is returned if the user did not | candidate. |
| | attend a ranked school, but it was accredited, | |
| | and a smaller arbitrary value is returned if the | |
| | user at least completed high school. | |
| salfeature | This feature uses data from Salary.com. An | Is there a small or |
| | API with Salary.com's job titles, alternate job | large difference |
| | titles and national average salaries was | between the salary the |
| | created. Job titles from the resume and job | candidate has made |
| | description are searched through the api and | previously, and that of |
| | salaries are returned. These are averaged | the job opening? |
| | for the job titles on the resume, and that of | |
| | the job description, and a difference between | |
| | the two averages is calculated and set as the | |
| | value of the Feature. This feature can be | |
| | normalized or expressed as a %-age. | |
| Gdfeature | This feature uses www.Glassdoor.com | Is there a small or |
| | employee ratings representing company | large difference |
| | prestige. An API was created to access this | between the prestige |
| | data. Past employers from the resume and | of the companies the |
| | job description are searched and their ratings | candidate has worked |
| | are averaged. A difference is calculated and | for previously, and that |
| | returned as the value of the feature. | of the job opening? |
| GFfeature | This feature uses Google Finance (Revere) | Has the candidate |
| | data representing related companies. An API | worked for a related |
| | was created to access this data. Past | company to that of the |
| | employers from the resume and job | job opening (Revere |
| | description are searched. Lists of related | data)? |
| | companies are compared vs. cosine | |
| | similarity. The peak cosine similarity is | |
| | calculated and returned as the value of the | |
| | feature. | |
| SUfeature | This feature uses Similar Group's urls (see, | Has the candidate |
| | e.g., www.similargroup.com/) representing | worked for a similar |
| | similar companies. An API was created from | company to that of the |
| | this data. Past employers from the resume | job opening (Similar |
| | and job description are searched and lists of | Groups url data)? |
| | related companies' urls are compared via | |
| | cosine similarity. Peak cosine similarity is | |
| | calculated and returned as the value of the | |
| | feature. | |
| SGfeature | This feature uses Similar Group's company | Has the candidate |
| | names representing similar companies. An | worked for a similar |
| | API was created from this data. Past | company to that of the |
| | employers from the resume and job | job opening (Similar |
| | description are searched and lists of related | Groups company |
| | companies are compared via cosine | names data)? |
| | similarity. Peak cosine similarity is calculated | |
| | and returned as the value of the feature. | |

TABLE 1J
Social Network Data

| Name of Feature | Technical Description | Verbal Description |
|---|---|---|
| CompanyConnections | Counts the number of 1st and 2nd degree | Counts the number of |
| | friends a candidate has, from social network | 1st and 2nd degree |
| | data, at the employer listing the job opening. | friends a candidate |
| | | has at a prospective |
| | | employer. |
| NetSize | Counts the number of 1st and 2nd degree | Counts the number of |
| | friends in a candidate's Facebook network. | 1st and 2nd degree |
| | | friends in a |
| | | candidate's Facebook |
| | | network. |

TABLE 1K
Management Level Analysis

| Name of Feature | Technical Description | Verbal Description |
|---|---|---|
| true_or_false | Determines the overlap of managerial | Uses a structural/ |
| | requirements of the job with managerial | keyword parser to |
| | experience on a resume. If both job and | semantically calculate |
| | resume are determined to be management or | the management |
| | both are determined to not be management, | status of the job and |
| | a score of 1 is given. If one is management | candidate. If there |
| | and the other is not, a score of 1 is given. | sufficient overlap a |
| | | score of 1 is given. If |
| | | there is a mismatch of |
| | | management between |
| | | the job and candidate, |
| | | a score of 0 is given. |
| just_true | Determines if both job and resume can be | Uses a structural/ |
| | described as managerial. If so, a score of 1 | keyword parser to |
| | is given. Otherwise, a score of 0 is given. | semantically calculate |
| | | whether both job and |
| | | candidate are |
| | | management. If so, a |
| | | score of 1 is given. |
| | | Otherwise, a score of |
| | | 0 is given |
| just_false | Determines if both job and resume are below | Uses a |
| | management. If so, a score of 1 is given. | structural/keyword |
| | Otherwise, a score of 0 is given. | parser to semantically |
| | | calculate whether both |
| | | job and candidate are |
| | | sub-management. If |
| | | so, a score of 1 is |
| | | given. Otherwise, a |
| | | score of 0 is given |

TABLE 1L
Further Miscellaneous Functions

| Name of Feature | Technical Description | Verbal Description |
|---|---|---|
| HR-XML- | Calculates the “wheelhouse” or “bailiwick” | Searches for keywords |
| taxonomyfeature | overlap of a job description and resume. | against a library |
| | These terms define the unique speciality of | of keywords and finds |
| | the candidate and as required for the job | the taxonomy and |
| | description. From the keywords in the job | subtaxonomy that |
| | description and resume, we determine the | groups these keywords |
| | major industry category for each, along with a | best. Depending |
| | specialty category within that major category. | on the amount of |
| | A grade of 0-4 is given, depending on how | overlap between the |
| | much overlap there is. | taxonomies of the job |
| | | description and |
| | | resume, a score of 0-4 |
| | | is given. |
| syn_skillsfeature | Utilizes synonym sets obtained from | Does the candidate |
| | Monster.com, via an API, to find desired skills | have the desired skills |
| | that overlap between the job description and | even if the exact skill |
| | resume. | is not listed, rather a |
| | | synonym is listed? |
| syn_reqskillsfeature | Utilizes synonym sets obtained from | Does the candidate |
| | Monster.com via and API to find required | have the required |
| | skills that overlap between the job description | skills even if the exact |
| | and resume. | skill is not listed, rather |
| | | a synonym is listed? |
| internfeature | This feature assesses whether education and | Is this an intern/entry |
| | on-the-job training are part of the job. | level position? If so, |
| | Eliminates people who are over-qualified or | experienced candidates |
| | who already have the qualification to be trained. | get a penalty. |

TABLE 1M
Features Based on SOC Codes

| Name of Feature | Technical Description | Verbal Description |
|---|---|---|
| maxmatch | This measures the amount of overlap of the | |
| | SOC's in the categories 1-6 | |
| broad | If the first 5 numbers between a job SOC and | Is the broad function |
| | a candidate's SOC are the same, this feature | the same? |
| | gets a value of 1; else, it gets a value of 0. | |
| detailed | If the SOC's are exactly the same between a | Is there an exact |
| | candidate's title on their resume and the title | match of SOC? |
| | of the job opening, this feature gets a value of | |
| | 1; else, it gets a value of 0. | |
| chief_or_indian | This feature is 1 if the candidate has been a | Does the candidate |
| | manager in the past and the job opening is | have managerial |
| | for a management job. It is also 1 if the | experience in the case |
| | candidate has never been a manager and the | of a managerial job? |
| | job opening is a non-management job. The | Is the job |
| | feature is 0 in the case where the job opening | inappropriate for the |
| | is for a management job and the candidate | candidate because |
| | has never been a manager, or in the case | they are a manager |
| | where the candidate has management | and would need to |
| | experience and the job opening is for a non- | take on a non- |
| | management job. | managerial role, or |
| | | vice versa? |

It will be understood that the features listed in Table 1 are representative. A suitability score does not have to be based on all such features. Furthermore, other features derivable either from a candidate's resume, or from a job description, or from external data, and not explicitly listed in Table 1, can be contemplated and can be used in calculation of a suitability score, either in place of one or more features in Table 1, or in addition to those features. Additionally, the same underlying data that contributes to a feature described in Table 1 could be utilized to define a feature calculated by a different metric. For example, instead of presenting 1 or 0 for whether a candidate has held a management position in the context of a management level job opening, the feature could be designed as the (non-zero) number of management level positions held by the candidate, or the number of years during which the candidate has held management level positions.

The suitability score can also be based on features that utilize social media data and other sources of aggregate data mined from the web and public databases. Examples are shown in Tables 1H and 1J. An important example is salary information. One hypothesis is that if a candidate's recent salary is similar to the salary for the job opening to which they are applying, the candidate is more likely to be qualified for that position. Typically a candidate is not asked for their salary when their profile is created or their resume is uploaded, nor do job listings typically specify the salary range for the position. To estimate a candidate's salary, a commercial salary database (e.g., from www.salary.com) can be utilized, as well as public salary survey information from the Bureau of Labor Statistics. Since job titles on resumes are not normalized, the best tf-idf match between the candidate's recent job history and the job titles available from salary surveys can be used to estimate salary ranges. The same matching technique can be used to estimate the salary for a job opening, if the salary is not posted with the description of the job opening, and if a candidate has a high enough suitability score for the job.

A feature score, F, for a given feature can be calculated according to a metric selected from the group consisting of (but not limited to): cosine overlap; Tanimoto coefficient; Jaccard coefficient; Dice coefficient; and Tversky index. Generally, as described elsewhere herein, some features lend themselves to being normalized in the range [0,1], whereas others may be binary quantities, and still other features may not have an upper bound.

Typically, a suitability score, S, is a number between 0 and 100, though other normalization schemes could be used, such as a number between 0 and 10, and a number between 0 and 1,000. It is also possible that a scoring system could be un-normalized, and simply be expressed as a number proportional to the goodness of fit between a resume and a description of a job opening, in which case the larger the number (with no upper bound) the more suited is a candidate for a job opening.

Typically, when calculating a suitability score, each feature score is weighted by a coefficient derived from a statistical analysis of sample resumes and sample job descriptions, whose matches to one another have been ranked by individuals whose primary profession is recruiting. A study that is the basis of such a statistical analysis is described in Example 1 herein.

One method of deriving a weighting coefficient used to determine the contribution of a feature score to the suitability score is to: obtain a t-statistic estimated discriminating power for the feature. This can be done by comparing the feature score to a probability distribution function for that feature obtained for a set of resumes that have been ranked by individuals whose primary profession is recruiting, thereby determining whether the feature is a quantity that indicates a good match between the candidate and the job opening. If the feature is such a quantity, a weight can be applied to the feature based on the discriminating power. If the feature is not such a quantity, it will typically still play a role in the certain types of matches because features that do not have discriminating power for typical resume-job pairs stay in the calculation of suitability score, and may be important for some employers. For example, it is possible to adapt the form of the suitability score for different employers. Features such as mis-spellings (typgographical errors) in candidates' resumes may be unimportant to some employers, but may be very relevant to hiring considerations of other employers or categories of employers. The mathematical framework for calculating a suitability score for all candidate-job opening pairs can also be utilized to derive a customized score for a specific employer. In this way, the development of a suitability score can be, and preferably is, a dynamic process. The scoring function can be updated for a particular employer as and when its preferences become known.

Another way of deriving a weighting coefficient for a feature is to analyze data from a large scale comparison of resumes to job openings using a method selected from machine learning; neural networks and other multi-layer perceptrons; support vector machines; principal components analysis; Bayesian classifiers; Fisher Discriminants; Linear Discriminants; Maximum Likelihood Estimation; Least squares estimation; Logistic Regressions; Gaussian Mixture Models; Genetic Algorithms; Simulated Annealing; Decision Trees; Projective Likelihood; k-Nearest Neighbor; Function Discriminant Analysis; Predictive Learning via Rule Ensembles; Natural Language Processing, State Machines; Rule Systems; Probabilistic Models; Expectation-Maximization; and Hidden and maximum entropy Markov models. Each of these methods can assess the relevance of a given feature of a resume for purposes of suitability for a job opening, and provide a quantitative weighting of each.

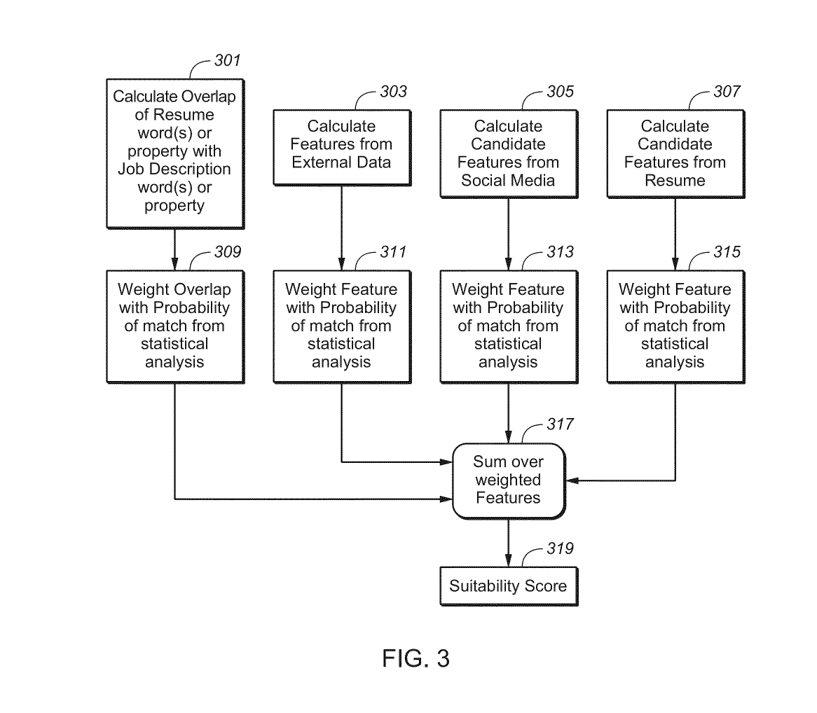

A schematic that illustrates, without mathematical detail, an assembly of a suitability score is shown in FIG. 3. Various feature scores based on a candidate's resume, the job description, or an overlap of the two are calculated. For example, such feature scores could be based on: a calculated overlap of a resume word or property and a job description word or property 301; a calculated score for a piece of external data such as a ranking of an educational institution 303; a calculated score for a piece of data about the candidate obtained from social media 305; and a calculated score for an aspect of the candidate's resume such as its word count 307.

Each of the respective feature scores is then weighted, 309-315, with a factor based on a probabilistic analysis of the importance of that feature. The probabilistic analysis is, as described elsewhere herein, based on a large-scale evaluation of many resume-job opening pairs. Feature scores are weighted according to how likely the value of the score for that feature is to lead to the candidate being considered a match for the job opening. The weighted feature scores are summed 317, thereby creating an overall suitability score 319.

The suitability score, S, can preferably be assembled in the following way. For a candidate u and a job j, we calculate feature scores Fᵢ(u,j), where i=1−N, and N is the number of features calculated. The calculation of feature scores can be as described for each of the features in Table 1.

Based on (candidate, job) pairs where a match score Q has already been determined by a human evaluation, Probability Distribution Functions can be created: Pᵢ(Q|Fᵢ) is the probability that the match score is Q given a feature value Fᵢ.

In the simplest example, the grading data allows two possible scores, a match (Q=1) and a non-match (Q=0). A match means the person is a good fit for the job, and a non-match means the person is not deemed, by the human grader, to be a good fit for the job. For example, if a feature is educational level attained by the candidate, and the match with a job opening is 1 (from a binary consideration), then Pᵢ(Q|Fᵢ) might be a single-valued function having a value of 70%, meaning that if a candidate has the right level of education for the position, the chance of them being judged suitable for the position is 70%.

Thus, for a two value situation, such as educational level, the student's two sample t-statistic, tᵢ, can be calculated for each such feature based on the data from the human-graded study.

For an unknown candidate-job pairing, a suitability score, S(u,j) for a candidate u and job description j, can then be calculated according to the following pseudo-code:

function Suitability_Score(u,j):

| maxscore = 0 | |
|---|---|
| pairscore = 0 | Systems |
| for i in 1, N: | Analyst |

fval = Fᵢ(u, j)
maxscore = maxscore + tᵢ

if Pᵢ(1 | fval) > Pᵢ(0 | fval):

pairscore = pairscore + tᵢ

return pairscore/maxscore

In this pseudo-code, the return value of the function is the suitability score, S, for candidate u and job j. In turn, S is the ratio of the pairscore and the maxscore. Each of those quantities is obtained by summing over each of the N contributing features. The quantity maxscore is the sum of the t-statistics for each of the contributing features. The quantity pairscore is the sum of those t-statistics for each of the contributing features where its probability of contributing is positive as measured by its probability distribution function.

In other words, if a given feature value is mostly likely to come from the matched candidate-job sample, then a weight equal to the discriminating power t of that feature is added. The score, S, is normalized to the sum of the discriminating powers t. The fitting of real-time data to a probability distribution, per feature, achieves a normalization of each feature value before it is combined into the suitability score.

It should be understood, therefore, that the contribution of a particular feature score to an overall suitability score can change as more data on resume-job opening matching is obtained and evaluated.

Furthermore, the algorithms for calculating a suitability score can be further improved by use of several different filters depending upon the requirement of the job, the qualifications of the candidate, or by terms of the search that the candidate or employer performs. For example, if a candidate is a certified nurse practitioner and desires a job within that field, the first-level filter will find jobs that require this certification or a synonym of it (e.g., LNP). These filters are bidirectional and thus can be utilized by candidate or employer.

Many of these features and filters can be customized for an individual employer. Access to resumes and explicit feedback regarding the success of candidates in advancing to an interview or being hired, makes it possible to dissect historical hiring patterns of a company, both overall and for specific positions. It is then possible to identify correlations between the resumes of different candidates as well as between resumes and job descriptions to predict the top candidates for a given opening, and customize the suitability score specifically for an employer's requirements.

### EXAMPLES

### Example 1

### Learning Process

This example describes a first-of-its-kind large-scale nation-wide and scientifically controlled human evaluator study of the resume-job matching process, conducted with a view to developing a set of empirical data that can be used in training algorithms to optimize a scoring function of fitness or suitability of a candidate for a job opening. This study is the first example of data-driven algorithmic sourcing; in other words, an algorithm for matching a candidate with a job opening is derived from analysis of data gathered by evaluations of matches between other candidates and other job openings. The study has been referred to as the Human Insights Resume Evaluator Study (“HIRES”).

A high-level goal of an effective scoring function is that it emulates optimal human behavior during the resume evaluation process. Utilizing a large set of active job seekers and active job listings, a team of human resources professionals was asked to evaluate tens of thousands of resumes against job descriptions. The human evaluators scored the viability of each resume-job pair, to rate a pool of candidates as either qualified or not qualified for a given position.

In summary, it was found that traditional word vector techniques, in which key words from a resume are matched with key words for a position, helped to discriminate the qualified and non-qualified candidates, but that external user-generated content also improved the matching accuracy.

In particular, this example shows that augmenting the data contained in the resume and job listing with external data can improve the quality of a resume-job matching algorithm. The external data can take the form of simple industry-specific synonym and acronym sets, or can directly utilize employer or employee survey data and user-generated content.

One aspect is that the study utilized recruiters who did not work for the company whose positions they were hiring into, and who did not have expertise specific to a given industry. This situation is common where external recruiters are utilized by a company looking to fill job openings, and contrasts with the use of internal recruiting staff who know or have direct access to industry information which may be an important factor in the matching process.

The issue of recruiter familiarity with a given industry may be circumvented in part by comparing a candidate's high scoring matches to his or her social graph. Job openings to which a candidate scores highly will likely be from a company that employs someone within their first- or second-degree connections on their social graph. Thus, social data can influence an individual score, as well as the range of jobs that are scored for a given individual. In other words, social media has a multivariate effect on a suitability score.

Utilizing the HIRES study, it results that some of the external data can be important (for example, implicit salary estimates), whereas other data does not discriminate very well (for example, reputation of a candidate's previous employers).

### Data Sources

For the studies described, the fact of there being a study, and the identity of the organization commissioning the study was kept secret. Most candidates submitted resumes that were used in the study based on the marketing of specific jobs or job titles listed on a recruiting-oriented web-site. In order to apply for a given job opening, candidates were asked to register and upload a resume. There were several variations of the registration path, but different screens prompted the user (such as a candidate) for different pieces of information. It was mandatory that the users provide their name, e-mail address, and a zip-code. Users were prompted to connect via the social networking site, Facebook, but the majority of users decline to do so and skipped that step.

The Facebook connection would allow the study organizer to gather some basic profile data (such as where the candidate lives, educational history, current employer, and job title), as well as some information about the candidate's first degree Facebook connections (where their closest friends work, for instance).

After the mandatory registration and the optional connection to Facebook, users were prompted to either upload a resume or to fill out a series of pages that allow them to build a resume online.

The majority of users in this study uploaded an existing resume. The web-site accepted most common document formats (Adobe PDF, Microsoft Word .doc, and plain text). After the resume has been uploaded, the candidate confirms that they want to apply for the job in question.

The resumes and job listing were parsed using software that recognizes the various elements of the resume and/or job listing and then casts them in a semi-structured format (in this case, HR-XML, an electronic format developed for sharing human resource data; see for example www.hr-xml.org). The parser separates out contact information, experience, and education. It uses a list of common skills and certifications to determine which of those the candidate possesses, and at what level. Similarly, the job listing is parsed for company information, educational requirements, experience requirements, and any required skills and certifications.

### Human Evaluations of Job Resume Matches

A team of human resource (HR) professionals was recruited to create a training set upon which the most important features of a successful match between a candidate and a job opening could be determined. These evaluators themselves were recruited by placing an advertisement on the Internet web-site, Craig's List (e.g., www.craigslist.org), in several different cities. The HR professionals were recruited from multiple functions within HR, including sourcers, generalists, recruiters, and managers.

These professionals carried out their evaluations of the suitability of candidate resumes for a given job posting using an Internet web browser. The job description and resumes were shown either side-by-side or in sequence. In the first phase of the study, the evaluator was asked to determine if a candidate met the minimum qualifications for a position or not. As the study progressed, the evaluators were asked to give a letter grade (A, B, C, or F) to the suitability of the candidate, where F denotes a candidate who does not meet the minimum qualification(s) for the position.

Overall, the HIRES study rendered over 10,000 scored resume-job pairs, about 8,800 of which were unique. These were used for baseline studies. Various combinations of pairs of job descriptions and resumes were sent off to be screened by the professional evaluators. They were presented with different types of samples. One sample contained resume-job opening pairs in which the candidate had actually applied for the position in question. Another sample contained purely random combinations of resumes and job openings.

The approach described herein circumvents the shortcomings of other approaches, for example, that of Yi et aL, and instead used “explicit” feedback from HIRES to train the algorithms. Specifically, the evaluators in the study described herein first provided simple yes/no assessments of suitability of a candidate for a job opening, and then offered a letter grade.

Overall, only 33.6% of applicants were given the top grade by the evaluators, indicating that nearly two thirds of candidates are unlikely to advance to an interview for any given position to which they apply.

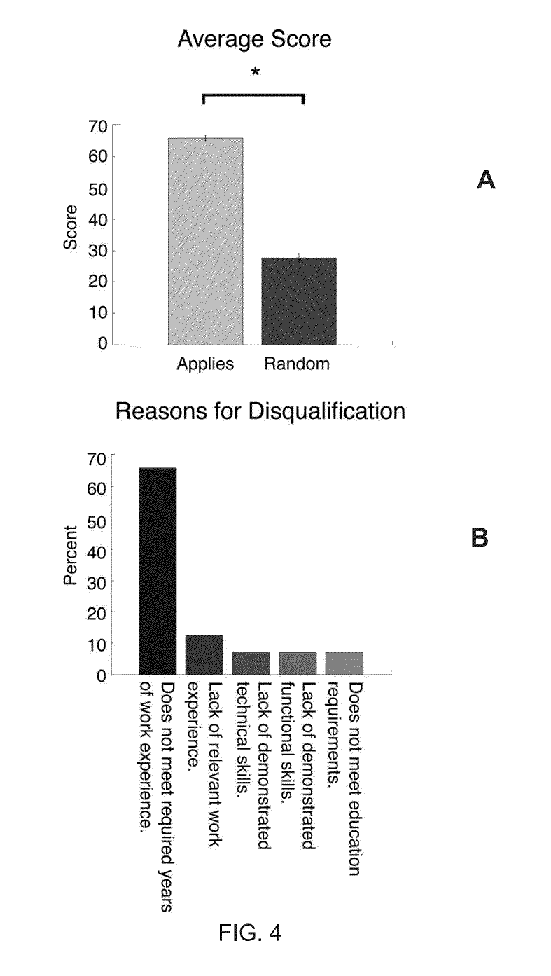

In HIRES, even purely random pairings resulted in as many as 27.6% of the resumes meeting minimum qualifications (0.28+/−0.015), whereas 67.6% of applicants met the minimum qualifications for a job to which they applied (0.66+/−0.0084), a highly significant difference (FIG. 4A; *=p<10⁻¹⁴).

FIG. 4B shows a list of reasons why candidates were deemed unqualified for particular job openings and the proportions of candidates who were disqualified for each reason. For candidates that were deemed unqualified for jobs they applied to, the most common reason was that they did not meet the required years of work experience, which was the cause for nearly two thirds of the disqualifications (65.8%).

In some instances, the same resume-job pairs were provided to many evaluators so that the consistency of the evaluation of candidate fitness for a position among the evaluators could be assessed or averaged. It was found that the evaluators' judgments were largely consistent, but that the evaluators had a different cut-off for deciding between unqualified and qualified. A small set of border-line resume job pairs were judged differently by different evaluators, which may be inevitable when working with human evaluators. Results from HIRES indicated that scoring was fairly consistent for the following categories: evaluator gender (Male: 51.92+/−23.22, Female: 46.63+/−12.04, p>0.15); evaluator type (Recruiter: 47.85+/−14.43, HR specialist: 48.07+/−16.02, p>0.9); and the evaluator's location (Chicago: 46.30+/−13.96, Boston: 49.69+/−28.69, Atlanta: 52.30+/−26.15, p values>0.2). The evaluators spent an average of 248.65 seconds (approximately 4 minutes) on each resume-job pairing, much longer than previously reported in a recent study by The Ladders: (cdn.theladders.net/static/images/basicSite/pdfs/TheLadders-EyeTracking-StudyC2.pdf) in which only 6 seconds was spent per evaluation. It is important to note that this difference may be due to differences in methodology: for HIRES, evaluators were required to grade a resume-job match, whereas the other study instructed evaluators to simply view the resume with a view to assessing what's important in the resume.

In addition to providing the basic training data for the algorithms described elsewhere herein for calculating a suitability score, the ongoing collection of human behavioral data will allow for the continuing evolution of the algorithm's ability to emulate optimal human behavior, immediately and effectively identifying the strongest applicants for each job posting.

### Example 2

### Identifying Features

In developing a suitability score, over 15-20 million unique job listings and 10 million candidates and resumes gathered from most of the major Internet-based job bulletin boards were processed. This data can be used for subsequent cluster analyses.

### Matching Features and Filters

During development of a suitability score, more than 100 features were designed and evaluated against the results of the HIRES study. An optimized subset of those 100 features is included in a final suitability score calculation. The development of these features evolved from intense investigation of relevant scientific and mainstream literatures as well as the systematic analyses of job descriptions and resumes as described herein.

The importance of individual features can be evaluated using the results of the HIRES study. For each candidate-job pairing, the study provides a human evaluation of whether the candidate meets minimum qualifications or does not. The feature values for each of the candidate-job pairs can be calculated. Then, a two-sample t-test can be utilized to see if the feature values come from the same underlying distribution. In Table 2, the results of these t-test evaluations are shown for a few representative features. Eye-tracking studies indicated that a human resume reader will focus most intently on the most recent job title. Hence, a natural feature that proves significant is the cosine similarity between the candidate's last title and the title of the job in question (denoted by cosim:title vs last-title).

TABLE 2
Sample feature names, t-values, and p-values for the HIRES study.

| Feature Name | t | p |
|---|---|---|
| cosim:title_vs_lasttitle | 15 | 6 × 10⁻⁴⁸ |
| skills match | 15 | 7 × 10⁻⁴⁸ |
| salary | 10 | 6 × 10⁻²³ |
| Glassdoor Score | −1.4 | 0.16 |
| (from www.glassdoor.com/index.htm) | | |
| Suitability Score | 23 | 6 × 10⁻¹¹² |

Also, in Table 2 is shown the t-value for the final suitability score calculation that incorporates all of the features. There is a strong linear correlation between the human evaluation and the calculated suitability score. For the sample, the t-statistic for the final suitability score (23) is significantly larger than any of the individual features.

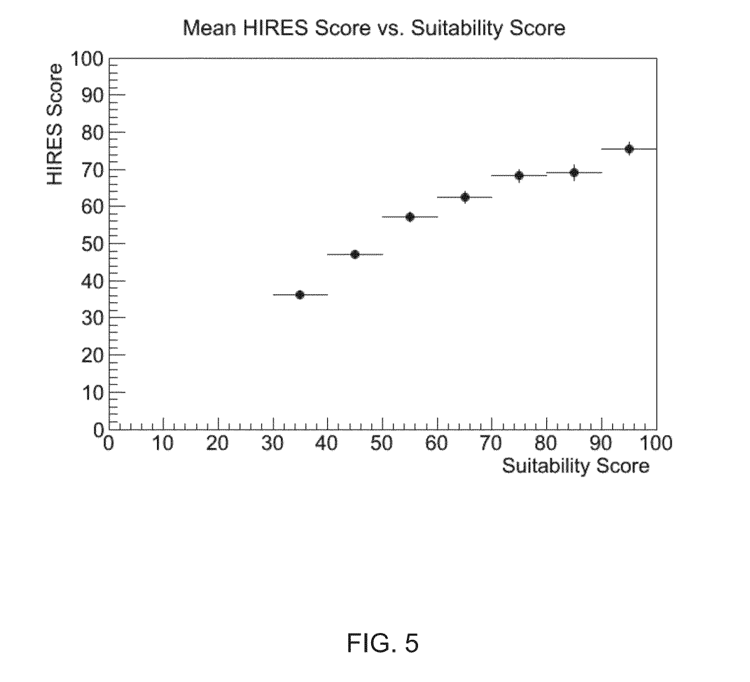

Strong evidence that the suitability score as described herein is emulating the performance of the HR professionals was revealed via a standardized method. This method, used extensively in peer-reviewed academic publications, involves training the classifier on a random sampling of the data and testing on the remaining sample. For this classifier 106 iterations of training were performed on 90% of the data, and testing on the remaining 10% of the dataset. The scatter plot in FIG. 5 displays a single iteration of this testing.

FIG. 5 shows a plot between the normalized human score (normalized to 100 based on a graded A, B, C, D, F scale) and the calculated score for a population of candidate resume pairs. This linear regression analysis revealed a strong correlation within the test sample between the suitability score and the corresponding normalized HIRES results (r=0.54, p<10-10). Overall, the t value resulting from the comparison of the suitability scores that received a pass grade in HIRES, versus those that received a fail grade, was highly significant (t=27.43, p<10-100). These results substantiate the performance of the suitability score in quantifying candidate-job viability and show that the suitability score based on various features correlates very well with human assessments of resumes.

An exemplary suitability score uses more than 50 separate matching features. Those with the highest discriminating power, according to the t-statistic analysis of the HIRES study, are termed vector space metrics (e.g., cosine similarities, tf-idf, and jaccard analyses). A second important class of matching features is related to the user's skills and the required skill for the position.

Several features have been investigated that specifically utilize social media data. Glassdoor is a web-site where employees can review their employers. Each employer gets an aggregate score related to employee satisfaction and employer prestige. This score can be utilized to see if people that work at prestigious companies (having a high Glassdoor score) are generally deemed more qualified for a given position than those who have worked at less prestigious companies. The t-statistic for this feature is −1.4 (p-value=0.16), consistent with no discriminating power.

### Example 3

### Calculating a Score

### A Unique Mathematical Formula

The suitability score is calculated by a machine-learning, data-driven relevancy algorithm that calculates the viability of a specific candidate for a particular job opening.

The final calculation of a suitability score consists of a novel fusion of machine learning and statistics. Utilizing explicit feedback data from HIRES, normalized probability distribution functions for the different HIRES scores were derived for each feature. As a new resume-job pairing is scored in real time, results of the feature calculations are modeled against these functions utilizing a supervised Bayesian classifier approach, and a difference in fit is determined for each feature. This fit result is then binarized and weighted by a combination of the t-value and Pearson's coefficient derived from the feature values and HIRES study. The result is then normalized, so that the distribution of scores is moved from the range of raw values to a more convenient range such as [0,100], and can be further weighted based upon certain specific constituents of the feature results (e.g., if the person holds the required certifications). The resulting score quantifies the viability of a candidate-job pairing.

A key component of the suitability score is the utilization of external data such as social media profiles and other publicly available data to enhance the information that is solely available in the job description and resume. This additional data can take many forms, including: information found in the user's Facebook or LinkedIn profiles, social connections, a curated database of company information, user-generated reviews of companies, salary surveys, scraped data from the web, and historical profiling among aggregated resumes. There is a substantial increase in the ability to discriminate qualified from non-qualified candidates by using public sources of social networking data.

In order to assess the discriminating power of each individual feature, a separate batch calculation was run for each feature, from which the t-statistic was calculated. This serves as an ostensible weighting coefficient for that feature's numerical contribution to the total suitability score. The mean value and standard deviation were also calculated for each feature for the resume-job pairs deemed “at least minimally qualified” by the HIRES study, and, separately, those that were deemed “not minimally qualified”. The various calculated means and standard deviations were used to parameterize respective probability distribution functions for “minimally qualified” and “not minimally qualified” resume-job pairs. In this way, it was possible to determine the likelihood that a resume is qualified or not for a job opening based solely on that feature value. If a feature value for a given resume-job pair fits the probability distribution for the “minimally qualified” curve best, then the proportional value of the t-statistic for that feature (relative to the sum of the t-statistics for features calculated for the specific job-candidate pair) is added to their suitability score; otherwise, nothing is added. By starting with an appropriately low value, and adding all of the t-statistics of features for which a resume-job pair scored “well” according to the probability distribution functions for each feature, it is possible to reach a value that correlates directly to how qualified a candidate is for that job.

### Example 4

### Application Program Interface

An implementation of the suitability score, called the Bright Score is available to job candidates, employers within Bright.com's employer center, and integrates into several ATS systems including Taleo and ADP. The result is a complex, and yet simple to use, tool that integrates seamlessly into the HR workflow and enables employers to quickly and efficiently “score their best candidates.”

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

What is claimed:

1. A method comprising:
receiving a resume of a candidate;
receiving a job opening provided by an employer;
identifying a plurality of job features in the job opening;
identifying a plurality of candidate features in the resume; and
calculating, using the processor, a suitability score for the job opening based on the plurality of candidate features and the plurality of job features.

2. The method of claim 1, further comprising:
calculating a feature score for each candidate feature in the plurality of candidate features by calculating an overlap between the candidate feature and a corresponding job feature in the plurality of job features;
multiplying the feature score for each candidate feature in the plurality of candidate features by a coefficient value derived a statistical analysis of sample resumes and sample job descriptions; and
wherein the calculation of the suitability score is further based on combining the feature score for each candidate feature in the plurality of candidate features.

3. The method of claim 1, further comprising:
receiving information about the candidate from a social media source; and
wherein the identification of the plurality of candidate features is further based on the received information.

4. The method of claim 1, further comprising:
transmitting a notification to the employer when the suitability score exceeds a first threshold.

5. The method of claim 2, further comprising:
determining a preferred threshold, wherein the preferred threshold is higher than the first threshold; and
transmitting an immediate notification of the resume to the employer if the suitability score exceeds the preferred threshold.

6. The method of claim 2, further comprising:
transmitting a notification to the candidate when the suitability score exceeds a second threshold.

7. The method of claim 1, wherein the resume has an associated tag indicating a preferred job type for the candidate, the method further comprising:
transmitting a notification to the candidate when the suitability score exceeds a second threshold and the preferred job type corresponds to one of the plurality of job features in the job opening.

8. The method of claim 1, wherein the employer has identified a candidate feature, the method further comprising:
transmitting a notification to the employer when the suitability score exceeds a first threshold and the identified candidate feature is present in the plurality of candidate features of the resume.

9. The method of claim 1, wherein the employer has identified a candidate feature, the method further comprising:
transmitting a notification to the employer when the suitability score exceeds a first threshold and the identified candidate feature is absent in the plurality of candidate features of the resume.

10. The method of claim 1, further comprising:
determining an interest level for the candidate based on behaviors by the candidate; and
transmitting a notification to the employer when the suitability score exceeds a first threshold and the interest level exceeds an interest threshold.

11. The method of claim 1, further comprising:
determining a at least one preference for the employer, wherein the at least one preference includes at least one candidate feature; and
transmitting a notification to the employer when the suitability score exceeds a first threshold and the at least one candidate feature is present in the plurality of candidate features of the resume.

12. The method of claim 11, wherein the at least one preference for the employer is determined by statistical analysis of previous decisions by the employer on candidates for previous job openings.

13. The method of claim 1, wherein the suitability score is further based on salary information about the positions the candidate has previously held.

14. The method of claim 1, wherein the suitability score is further based on ranking information about the schools that the candidate attended.

15. The method of claim 1, further comprising:
presenting a skill to the employer, the skill being based on similar job descriptions submitted by the employer;
receiving a relative importance rating for the skill from the employer; and
wherein the suitability score is further based on the relative importance rating for the skill.

16. The method of claim 1, wherein each feature of the plurality of candidate features is selected from the group consisting of:
job title for each of one or more jobs previously held by the candidate;
length of time the candidate held each of one or more previous jobs;
subject matter of each of one or more qualifications obtained by the candidate;
job title of most recent job held by candidate;
whether the candidate has previously held a management position;
ranking of school attended;
highest educational level attained by candidate; and
number of commonly misspelled words in the resume.

17. The method of claim 1, wherein the suitability score is calculated according to a metric selected from the group consisting of:
cosine overlap;
Tanimoto coefficient;
Jaccard coefficient;
Dice coefficient; and
Tversky index.

18. A system comprising:
a first input connection that receives a resume from a candidate;
a second input connection that receives a job opening from an employer;
a memory to store the resume and the job opening; and
one or more processors configured with instructions to:
identifying a plurality of job features in the job opening;
identifying a plurality of candidate features in the resume; and
calculating, using the processor, a suitability score for the job opening based on the plurality of candidate features and the plurality of job features.

19. The system of claim 18, further comprising a communication device for transmitting a notification to the employer when the suitability score exceeds a first threshold.

20. The system of claim 19, further comprising the communication device transmitting a notification to the candidate when the suitability score exceeds a second threshold.
